(19) United States
(12) Patent Application Publication
(10) Pub. No.: US 2025/0092577 A1
(43) Pub. Date: Mar. 20, 2025

(54) RECYCLABLE ELASTIC FILAMENT BASED ON A POLYAMIDE-POLYETHER BLOCK COPOLYMER

(71) Applicant: ARKEMA FRANCE, COLOMBES (FR)

(72) Inventors: Quentin PINEAU, Serquigny (FR); Ludovic LUCE, Serquigny (FR); Sébastien Jun MOUGNIER, Serquigny (FR)

(73) Assignee: ARKEMA FRANCE, COLOMBES (FR)

(21) Appl. No.: 18/292,271

(22) PCT Filed: Jul. 25, 2022
(86) PCT No.: PCT/FR2022/051482

§ 371 Date: Jan. 25, 2024

(30) Foreign Application Priority Data
Jul. 26, 2021 (FR) FR2108074

(51) Int. Cl. D01F 6/82; C08G 69/40; C08J 11/06; D01F 8/12; D01F 8/16; D03D 15/283; D03D 15/56

(52) U.S. Cl. CPC D01F 6/82; C08G 69/40; C08J 11/06; D01F 8/12; D01F 8/16; D03D 15/283; D03D 15/56; C08J 2377/02; C08J 2377/04; D10B 2331/02; D10B 2331/06; D10B 2401/061

(57) ABSTRACT

The invention relates to an elastic filament comprising a copolymer containing polyamide blocks and polyether blocks, —the polyamide blocks being chosen from PA 11, PA 12, PA 1010, PA 1012, PA 1014, the copolymer thereof and the mixture thereof, —the polyether blocks being blocks derived from polytetramethylene glycol having a weight-average molecular mass of between 500 and 3000 g/mol, —the enthalpy of fusion of the copolymer being between 15 and 50 J/g.

The present invention relates to a recyclable elastic filament based on a polyamide-polyether block copolymer. The invention also provides a fiber comprising at least one filament according to the invention, a textile material, a process for manufacturing the filament, the use of the fiber for manufacturing woven and nonwoven materials, and also on the textile material. Finally, the invention relates to a process for recycling the fibers according to the invention.

The use of synthetic textile fibers based on polyamide has been known for many years. The textiles include in particular fiber mats (dressings, filters, felt), rovings (dressings), yarns (yarns for sewing, yarns for knitting, yarns for weaving), knitted fabrics (rectilinear, circular, fully-fashioned), fabrics (traditional fabric, Jacquard fabric, multiple fabric, double-sided fabric, multi-axial fabric, 2D and 2.5D fabric, 3D fabric), and many others. Innovations in this field appear regularly, such as for example for sportswear, which enable easier elimination of sweat. Furthermore, elastic textiles based on polyurethane have been developed since the 1960s. These synthetic fibers are known under the name “elastane”. This name is a contraction of elastic and polyurethane. These fibers are used in particular in the field of sport, or else in elastic fabrics, which can comprise between 2% and 10% of elastane in their composition. For sports tights, elastic bands or else socks, the content of elastane in the garment can range up to 30% by weight.

These fibers have particularly advantageous features, such as an elongation that can range up to 600%, an elastic return of greater than 90%, and also a very low weight.

Now, in the context of current environmental considerations, the recyclability of materials is a major issue, and in particular of textile materials, which are produced in considerable quantities.

It turns out that elastanes are crosslinked polyurethanes. This crosslinking prevents the recycling of these fibers since, after crosslinking, these fibers are no longer heat-fusible.

Alternatives do exist, such as polyesters and elastolefins, but their elasticity is limited and these materials are not compatible with polyamides.

Consequently, there is a desire for recyclable elastic filaments which have an improved elasticity, and which are compatible with other textile fibers, such as for example polyamides. There is also a desire for textile materials which enable a recycling process which is simple to perform, that is to say which requires only a few steps. The interest is also in obtaining a valuable recycled product, that is to say which leads to a high-performance product either for the same application or for other industrial applications.

Within the meaning of the present invention, “polymer compatible with other textile fibers” means that during recycling, and in particular after the melting step, the molten material is homogeneous.

It has been discovered that the filaments according to the invention meet the existing need.

### BRIEF DESCRIPTION OF THE INVENTION

Thus, a subject of the present invention is an elastic filament comprising a copolymer containing polyamide blocks and polyether blocks,
the polyamide blocks being chosen from PA 11, PA 12, PA 1010, PA 1012, PA 1014, the copolymer thereof and the mixture thereof,
the polyether blocks being blocks derived from polytetramethylene glycol having a number-average molar mass of between 500 and 3000 g/mol,
the enthalpy of fusion of the copolymer being between 15 and 50 J/g.

The invention is aimed at a fiber manufactured from the filament as defined below or else containing said filament.

The invention is aimed at a textile material manufactured from the fiber as defined below.

Another subject of the invention is a process for manufacturing the fiber.

The invention also relates to the use of the filament for manufacturing textile materials.

Finally, the invention relates to a process for recycling the filament, the fibers or the textile material according to the invention.

The filament according to the invention has the advantage of being able to be recycled. Its rheological stability allows it to be easily remelted and reused to manufacture granules, leading to new objects, for new applications such as for example new fibers. The property of the fiber according to the invention when remelted several times is very close, even identical, to those of the fiber when melted for the first time.

### DETAILED DESCRIPTION OF THE INVENTION

Other characteristics, aspects, subjects and advantages of the present invention will become even more clearly apparent on reading the description which follows.

In the present description of the invention, including in the examples below:
The term “thermoplastic polymer” means a polymer having the property of softening when it is sufficiently heated, and which, on cooling, becomes hard again.
The term “thermoplastic elastomer” means a polymer comprising flexible segments and rigid segments, for example in the form of a block copolymer, in which the rigid segments disappear when the temperature increases. Alternatively, this may be mixtures combining the presence of a flexible elastomeric phase, which is or is not crosslinked, dispersed in a rigid continuous thermoplastic phase. The mixtures may in particular be mixtures of a thermoplastic polymer with an elastomer.
The term “copolymer” means a polymer resulting from the copolymerization of at least two types of monomer which are chemically different, referred to as comonomers. A copolymer is thus formed of at least two different repeat units. It can also be formed of three or more repeat units. More specifically, the term “sequential copolymer” or “block copolymer” means copolymers within the abovementioned meaning, in which at least two distinct monomer blocks are linked by a covalent bond. The length of the blocks can be variable. Preferably, the blocks are composed of 1 to 1000, preferably 1 to 100, and in particular 1 to 50 repeat units. The link between the two monomer blocks can sometimes require an intermediate non-repeating unit known as a junction block.
The term “melting temperature” means the temperature at which an at least partially crystalline polymer changes to the viscous liquid state, as measured during the first heating (Tf1) by differential scanning calorimetry (DSC) in accordance with the standard NF EN ISO 11 357-3 using a heating rate of 20° C./min.
The term “enthalpy of fusion” means the heat consumed during the solid/liquid transition of the thermoplastic elastomer, as measured by differential scanning calorimetry, in accordance with the standard ISO 11357-3:1999.

The nomenclature used to define the polyamides is described in the standard ISO 1874-1:2011, “Plastics—Polyamide (PA) Moulding and Extrusion Materials—Part 1: Designation”, in particular on page 3 (tables 1 and 2), and is well known to those skilled in the art.

Furthermore, it is specified that the expressions “between . . . and . . . ” and “from . . . to . . . ” used in the present description should be understood as including each of the limits mentioned.

The word “polyamide” covers both homopolyamides and copolyamides.

In the present description of the invention, the following definitions apply:
“textile material” or “textile” means any material produced from fibers or from filaments and also any material forming a porous membrane characterized by a length/thickness ratio of at least 300;
“fiber” means any synthetic or natural material characterized by a length/diameter ratio of at least 300;
“filament” means any fiber of infinite length.

The invention is now described in more detail and in a nonlimiting manner in the description which follows.

### The Filament

The invention relates to elastic filament comprising a copolymer containing polyamide blocks and polyether blocks,
the polyamide blocks being chosen from PA 11, PA 12, PA 1010, PA 1012, PA 1014, the copolymer thereof and the mixture thereof,
the polyether blocks being blocks derived from polytetramethylene glycol having a number-average molar mass of between 500 and 3000 g/mol,
the enthalpy of fusion of the copolymer being between 15 and 50 J/g.

In general, the number-average molar mass of the polyethers is disclosed in the data sheets provided by the suppliers, the polyether being an available commercial product.

If necessary, the number-average molar mass Mn of the polyether blocks comprised in the filament according to the invention may be measured before copolymerization by size exclusion chromatography (SEC) in accordance with ISO 16014-1:2012 using hexafluoroisopropanol (HFIP) as eluent, and for 24 h at room temperature at a concentration of 1 g/l before the molar mass is measured by the refractive index.

The copolymer containing polyamide blocks and polyether blocks, also known as copolyether block amides, or abbreviated to “PEBA”, results from the polycondensation of polyamide blocks bearing reactive ends with polyether blocks bearing reactive ends, such as, inter alia:
1) polyamide blocks bearing diamine chain ends with polyoxyalkylene blocks bearing dicarboxylic chain ends;
2) polyamide blocks bearing dicarboxylic chain ends with polyoxyalkylene blocks bearing diamine chain ends, obtained by cyanoethylation and hydrogenation of α,ω-dihydroxylated aliphatic polyoxyalkylene blocks, known as polyetherdiols;
3) polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a dicarboxylic acid chain limiter. The polyamide blocks bearing diamine chain ends originate, for example, from the condensation of polyamide precursors in the presence of a diamine chain limiter.

### Rigid Polyamide Block

The copolymer containing polyamide blocks and polyether blocks comprised in the filament according to the invention comprises at least one polyamide block chosen from PA 11, PA 12, PA 1010, PA 1012, PA 1014, the copolymer thereof and the mixture thereof.

In other words, the polyamide block contained in the copolymer according to the invention is obtained by polycondensation of at least one linear aliphatic unit chosen from undecanolactam, lauryllactam, 11-aminoundecanoic acid (denoted 11), 12-aminododecanoic acid (denoted 12), the unit obtained by polycondensation of decanediamine and sebacic acid (denoted 1010), the unit obtained by polycondensation of decanediamine and dodecanedioic acid (denoted 1012), the unit obtained by polycondensation of decanediamine and tetradecanedioic acid (denoted 1014). Preferably, the PA blocks contained in the copolymer according to the invention are PA11 and PA12, the copolymer thereof and the mixture thereof.

According to one embodiment of the invention, the number-average molar mass of the rigid polyamide blocks is between 500 and 4000 g/mol and preferably between 600 and 2000 g/mol.

The number-average molar mass may be determined from the quantities of the reactants introduced into the reaction medium during the synthesis of the polyamide blocks. This mass may then be verified on the final copolymer by NMR.

### Flexible Polyether Block

The copolymer containing polyamide blocks and polyether blocks comprised in the filament according to the invention comprises at least one block consisting of tetramethylene glycol units, also referred to as polytetrahydrofuran and hereinafter denoted PTMG. The block consisting of tetramethylene glycol units comprises OH chain ends. It is also possible to modify these ends to an amine function.

The flexible polyether blocks may comprise PTMG blocks bearing NH₂ chain ends, such blocks being able to be obtained by cyanoacetylation of the PTMG blocks. More particularly, use may be made of the Jeffamine products (for example Jeffamine® D400, D2000, ED 2003, XTJ 542, which are commercial products from Huntsman, also described in patent documents JP2004346274, JP2004352794 and EP1482011).

The flexible polyether blocks may also comprise PTMG blocks bearing PPG-NH₂ chain ends. In other words, the PTMG chain ends with a propylene glycol unit, then with an amine function.

The number-average molar mass of the flexible PTMG blocks is between 500 and 3000 g/mol, preferably between 650 and 2500, and more particularly between 1000 and 2000, g/mol.

### Block Copolymer

According to the present invention, “elastic” means the ability of the filament or fiber to return to, at least, 80% of the initial length L0 after release of the stress applied to this same filament or fiber, under the conditions of the test below.

Elasticity is measured using a universal testing machine having a maximum capacity of 10 N. The initial length of the filament is L0=100 mm and a deformation rate of 100 mm/min. These conditions make it possible to identify the yield point of the filaments. A pre-load of 0.02 N is applied at the start of the test in order to limit the variation in the length of the foot of the curve. A break of 1 minute is applied before each elongation or relaxation. The values are based on a minimum of 5 test specimens or filaments.

The copolymer comprised in the filament according to the invention has an enthalpy of fusion of between 15 and 50 J/g, measured in accordance with the standard as defined above, preferably between 15 and 40 J/g, and more particularly between 20 and 40 J/g.

The number-average molar mass of the polyamide blocks and of the polyether blocks may be determined after copolymerization of the blocks by NMR. Measurement protocols are described in detail in the article “Synthesis and characterization of poly(copolyethers-block-polyamides)-II. Characterization and properties of the multiblock copolymers”, Maréchal et al., Polymer, Volume 41, 2000, 3561-3580, and also in the article by V. Girardon et al, Eur. Polym. J., Vol 34, p. 363-380, 1998.

Advantageously, in the copolymer comprised in the filament according to the invention, the weight ratio of the polyamide blocks to the polyether blocks is between 0.3 and 3, preferably between 0.3 and 2, and more particularly between 0.5 and 2.

The copolymer comprised in the filament according to the invention has, preferably, a hardness measured in accordance with the standard ISO 868, measured after 1 second after conditioning for 15 d at 23° C. and 50% relative humidity, of between 30 and 55 ShD, preferably between 30 and 40 ShD.

Preferably, the filament according to the invention has a melting temperature of less than or equal to 150° C., and preferably less than or equal to 130° C.; and/or a melt volume rate MVR of 2 to 200 cm³/10 min, and preferably 5 to 70 cm³/10 min.

The elastic filament according to the invention may consist of the copolymer as defined above.

According to another embodiment, the filament according to the invention may comprise at least one other thermoplastic material.

The thermoplastic material may be chosen from polyamides, polyethylene terephthalates, polypropylenes, polyethylenes, PEBA copolymers other than that according to the invention.

According to one embodiment according to the invention, the filament may be manufactured by co-extrusion. This co-extruded filament may take two or three different materials.

According to one embodiment, the filament is co-extruded with another thermoplastic material chosen from polyamides, polyethylene terephthalates, polypropylenes, polyethylenes, PEBA copolymers other than that defined according to the invention.

The co-extruded filament may have different structures: core-skin, sea-island or else trilobal.

According to a preferred embodiment of the invention, the filament is co-extruded, it comprises the copolymer containing polyamide blocks and polyether blocks as defined above and polyamide, the core of the filament being made of PEBA according to the invention and the skin of the filament being made of polyamide.

These co-extruded filaments may be commingled to manufacture fibers.

### Process for Preparing the Copolymer

The block copolymer comprised in the filament according to the invention may be prepared in a manner known by those skilled in the art, for example, by mixing in the molten state the polyamide and PTMG blocks.

Alternatively, the block copolymer may be prepared by mixing in the molten state the monomers constituting the polyamide and PTMG blocks.

The process for synthesizing the copolymer defined above may comprise the following steps:
mixing and reacting at least one PA block with at least one PTMG block,
recovering said copolymer.
   According to a preferred embodiment, the process according to the invention comprises the following steps:
charging a reactor with a mixture comprising at least one PA block, at least one PTMG block,
heating to a setpoint temperature within the range from 180° C. to 340° C., preferably from 200° C. to 300° C., preferably from 220° C. to 270° C.,
stirring and flushing with inert gas,
placing under vacuum at a pressure of less than 100 mbar, preferably less than 50 mbar, preferably less than 10 mbar,
adding a catalyst,
stopping when a torque at least equal to 5 N·cm, preferably at least equal to 10 N·cm, preferably at least equal to 20 N·cm, is reached.

### Process for Manufacturing the Filament

All the processes of melt spinning may be used, in particular by making the copolymer defined above pass through spinnerets comprising one or more orifices. For the manufacture of multifilament yarns or fibers, mention is made of the processes of spinning or spin-drawing or spin-draw-texturing, which may or may not be integrated, whatever the spinning speed may be. The yarns may be produced by high-speed spinning, at a spinning speed of greater than or equal to 3000 m/min, preferentially greater than or equal to 4000 m/min. Such processes are often denoted by the following terms: POY (partially oriented yarn), FOY (fully oriented yarn), ISD (integrated spin-drawing), HOY (highly oriented yarn with a speed of greater than 5500 m/min). These yarns or fibers may also be textured, depending on the use for which they are intended. The yarns or fibers obtained by these processes are particularly suitable for the production of woven or knitted textile surfaces. According to the invention, the copolymer defined above may be used for the manufacture of monofilament yarns or fibers or monofilaments, of multifilament yarns or fibers or multifilaments, of continuous fibers (on reels) or of discontinuous fibers (cut). The discontinuous filaments are particularly well suited for mixing with natural fibers.

For individual filaments or monofilaments, the linear densities may range from 1 dtex to 1000 dtex/filament, the high linear densities being particularly well suited for industrial applications. Multifilament yarns or fibers preferably have a linear density of less than or equal to 15 dtex/filament. For the manufacture of fibers, the filaments may for example be joined together in the form of a roving or lap, directly after spinning or in a subsequent operation, drawn, textured or crimped and cut.

Typically, the polymer is spun in the molten state, then drawn between 2 and 10 times its length, preferably 5 times its length at room temperature, then the yarn is retracted at room temperature and preferably stabilized at 100° C.

### The Fiber

The invention also relates to a fiber comprising at least one filament as defined above.

The fiber or fibers according to the invention may comprise one or more synthetic filaments different from that defined above and/or may comprise one or more natural filaments.

The fibers according to the invention may be used for the manufacture of nonwovens or spun fiber yarns. The filament or the fiber may also be used for the manufacture of flocks. The filaments and fibers of the invention may undergo various treatments such as, for example, drawing in one continuous step or in a subsequent operation, deposition of sizing agent, oiling, braiding, texturing, crimping, drawing, setting or relaxing heat treatment, throwing, twisting, and/or dyeing.

For dyeing, mention is in particular made of bath or jet dyeing. The preferred dyes are metalliferous or nonmetalliferous acid dyes. Solution dyeing processes may also be conceivable, by virtue of the use of a masterbatch.

In one embodiment, the tenacity of the fiber according to the invention is 0.3 cN/dTex, in particular greater than 0.5 cN/dTex; in particular, it is from 0.5 to 10 cN/dTex.

The fiber according to the invention may be commingled with at least one fiber made of a thermoplastic matrix different from the PEBA copolymer defined above.

The thermoplastic material may be chosen from polyamides, polyethylene terephthalates, polypropylenes, polyethylenes, PEBA copolymers other than that according to the invention.

The fiber according to the invention may be continuous or discontinuous.

### Textile Material

Another subject of the invention is a textile material comprising at least one filament as defined above or else at least one fiber as defined above.

Preferably, the textile material according to the invention comprises at least one fiber made of a thermoplastic material. Preferably, the thermoplastic material may be chosen from polyamides, polyethylene terephthalates, polypropylenes, polyethylenes, PEBA copolymers other than that according to the invention. More particularly, the fiber is made of polyamide, preferably chosen from PA46, PA6, PA66, PA610, PA612, PA1010, PA1012, PA11, PA12, the copolymers thereof and the mixtures thereof.

The textile material according to the invention may also comprise one or more synthetic fibers different from that defined above and/or may comprise one or more natural fibers. The natural fibers may be chosen from cotton, wool, and silk, artificial fibers may be manufactured from natural starting materials, metal fibers and/or synthetic fibers other than fibers comprising copolymer filaments as defined above.

Advantageously, said textile comprises synthetic fibers obtained from biobased starting materials. Preferably, the textile according to the invention is manufactured solely from biobased starting materials, such as for example textile materials based on PA11, PA1010 and biobased PEBAs.

The term “starting materials of renewable origin” or “biobased starting materials” means materials which comprise biobased carbon or carbon of renewable origin. Specifically, unlike materials derived from fossil substances, materials composed of renewable starting materials contain 14C. The “content of carbon of renewable origin” or “content of biobased carbon” is determined by application of the standard ASTM D 6866 (ASTM D 6866-06) and, where appropriate, of the standard ASTM D 7026 (ASTM D 7026-04). The first standard describes a test for measuring the 14C/12C ratio of a sample and compares it with the 14C/12C ratio of a reference sample of 100% biobased origin, to give a relative percentage of biobased C in the sample. The standard is based on the same concepts as 14C dating, but without applying the dating equations. The ratio thus calculated is termed the “pMC” (percent Modern Carbon). If the material under analysis is a mixture of biomaterial and fossil material (with no radioactive isotope), then the pMC value obtained is directly correlated to the amount of biomaterial present in the sample. The standard ASTM D 6866-06 proposes several techniques for measuring the content of 14C isotope, these being based either on LSC (Liquid Scintillation Counting) liquid scintillation spectrometry, or on AMS/IRMS (Accelerator Mass Spectrometry coupled with Isotope Radio Mass Spectrometry). The measurement method preferentially used in the case of the present invention is the mass spectrometry described in the standard ASTM D 6866-06 (“accelerator mass spectroscopy”).

The textiles of the invention containing polyamide blocks made of PA11 according to the invention at least partly originate from biobased starting materials and therefore have a content of biobased carbon of at least 1%, which corresponds to a ¹²C/¹⁴C isotope ratio of at least 1.2×10⁻¹⁴. Preferably, the textiles according to the invention comprise at least 50% by mass of biobased carbon relative to the total mass of carbon, which corresponds to a ¹²C/¹⁴C isotope ratio of at least 0.6×10⁻¹². This content is advantageously higher, in particular up to 100%, which corresponds to a ¹²C/¹⁴C isotope ratio of 1.2×10⁻¹². The textiles according to the invention may therefore comprise 100% of biobased carbon or, conversely, result from a mixture with a fossil origin.

The textile material according to the invention may be a woven, knitted, nonwoven or laminated surface.

According to one embodiment, the textile material according to the invention may consist solely of the elastic filament according to the invention.

The textile according to the invention advantageously constitutes a felt, a filter, a film, a gauze, a cloth, a dressing, a layer, a fabric, a knitted fabric, a clothing article, a garment, a bedding article, a furnishing article, a curtain, a passenger compartment covering, a functional technical textile, a geotextile and/or an agrotextile.

Said textile is advantageously used in the medical field, hygiene, luggage, garments, clothing, household or home equipment, furnishings, carpets, automobiles, industry, in particular industrial filtration, agriculture and/or construction; more particularly, it is a textile material for clothing, parts of sports shoes, sportswear, sports socks, bags, medical textile materials, bandages, support stockings.

The present invention also relates to textile articles obtained by shaping the fiber according to the invention by an extrusion process notably by the molten route, in particular the extrusion of sheets, films and filaments. Films may thus be obtained by the processes mentioned above using a flat die. The films obtained may undergo one or various treatment steps, such as uniaxial or biaxial drawing, stabilizing heat treatment, antistatic treatment and/or sizing.

The invention also relates to the use of the filament as described above to manufacture a fiber.

Another subject of the invention is the use of the filament as described above to manufacture a textile material for clothing, parts of sports shoes, sportswear, socks, in particular sports socks, bags, medical textile materials, bandages, support stockings.

Another subject of the invention is the use of the fibers as described above to manufacture a textile material.

### Recycling Process

Another subject of the invention is a process for recycling the filament, the fiber or the textile material as defined above, comprising the following successive steps:
a) grinding the filaments, fibers or said material to obtain particles,
b) melting the particles to obtain a molten mixture, and
c) forming granules from the molten mixture on conclusion of step b).

Before these steps, the recycling process may comprise a step of separating (detaching) the fibers in the structure that contains them for example. For example, when the textile comprises fibers according to the invention and fibers that are not compatible with them, that is to say fibers leading, in the molten state, to an inhomogeneous mixture, then a step of separating the fibers may prove to be necessary.

The grinding step is performed so as to reduce the size of the material containing the filaments or fibers according to the invention. Thus, after the grinding, particles are obtained which may have, for example, a Dv50 size of 0.1 to 10 mm.

The grinding step may be performed in a counter-rotating pin mill, that is to say the mill comprises a first set of brushes rotating in one direction and a second set of brushes rotating in the opposite direction. Alternatively, the grinding step may be performed in a hammer mill or in a whirl mill.

The particles obtained after the grinding step are then melted so as to obtain a molten mixture of the material or of the fibers. According to certain embodiments, particles are melted in the presence of one or more additives which may comprise inert colorants such as titanium dioxide, fillers, surfactants, crosslinking agents, nucleating agents, reactive compounds, mineral or organic flame retardants, ultraviolet (UV) or infrared (IR) light absorbers, UV or IR fluorescent agents, waxes, heat stabilizers (for example phenolic or phosphorus based), antiblocking agents or antifoams. Typical fillers include talc, calcium carbonate, clay, silica, mica, wollastonite, feldspar, aluminum silicate, alumina, hydrated alumina, glass microspheres, ceramic microspheres, themoplastic microspheres, baryte, and wood flour.

The particles may be melted at a temperature ranging from 150° C. to 300° C., and preferably from 180° C. to 280° C., more particularly from 180° C. to 250° C.

Optionally, this process may comprise a step of filtering the molten mixture so as to remove the impurities having for example a particle size ranging from 5 μm to 1 mm.

Finally, the optionally filtered molten mixture is then used to form recycled granules. More particularly, the granules may be formed by extrusion.

When the textile material only comprises elastic filaments according to the invention, during its recycling, the material leads to a homogeneous mixture after the melting step. The granules obtained may be reused. They may, for example, be used to manufacture elastic filaments.

When the textile material comprises elastic filaments according to the invention and nonelastic PEBA filaments, during its recycling, the material leads to a homogeneous mixture after the melting step. The granules obtained may be reused. They may, for example, be used to manufacture elastic filaments.

When the textile material comprises elastic filaments according to the invention and polyamide filaments, during its recycling, the material leads to a homogeneous mixture after the melting step. The granules obtained may be reused. They may, for example, be used for another use than that of the textile.

According to certain embodiments, the recycled granules may be used for the manufacture of the fibers according to the invention.

According to other embodiments, the recycled granules may in particular be introduced into an extruder or an injection molding press to manufacture an extruded or injection-molded article.

Other aims and advantages of the present invention will become apparent on reading the examples which follow, which are given without any implied limitation.

### Examples

### 1. Preparation of the Copolymers

The copolymers illustrated in the table below are prepared by mixing the monomers in the molten state.

The table gives the number-average molar mass (g/mol) of the blocks present in the copolymer.

TABLE 1

| | | | | Enthalpy | |
|---|---|---|---|---|---|
| | PA11 | PA12 | | of fusion | Shore |
| PEBA | block | block | PTMG | (J/g) | D |
| 1 comparative | — | 600 | 2000 | 10 | 27 |
| 2 invention | 600 | — | 1000 | 18 | 32 |
| 3 invention | — | 2000 | 2000 | 30 | nd |
| 4 invention | — | 1000 | 1000 | 34 | nd |
| 5 invention | — | 850 | 2000 | 15 | nd |

The average molar masses are determined by NMR in accordance with the method described in the article by V. Girardon et al, Eur. Polym. J., Vol 34, p. 363-380, 1998.

The Shore D hardness is measured in accordance with the standard ISO 868, after 1 s after conditioning for 15 d at 23° C. and 50% relative humidity.

The enthalpy is determined in the second heating in accordance with the standard ISO 11357-1-3, at 20° C./min by integrating the endotherm of the polyamide phase, that is to say the endotherm having the highest temperature if there are several endotherms.

### 2. Manufacture of a Filament According to a First Method

Copolymer 5 is melted, and then is passed through a spinneret in order to manufacture a filament. Said filament is drawn at the outlet of the spinneret and then cooled by air. The filament is then drawn 4 times its length at room temperature, and then released at room temperature. The filament is then heat-set at 100° C.

### 3. Manufacture of a Filament According to a Second Method

Copolymers 1 and 2 were extruded so as to produce a monofilament yarn by the molten route, by means of a single-screw extruder coupled to a gear pump system guaranteeing a constant flow rate and ending with a spinneret of 0.6 mm per yarn, such that:
The extrusion temperature is 220° C.
The monofilament yarn is cooled in water thermally regulated at 20° C.
The drawing of the yarn in its solid part is 3.5/1, carried out by virtue of two identical drawing operations of 1.87/1 carried out at a temperature of less than 60° C.
The relaxation of the yarn is 15% after drawing and before winding of the yarn onto a reel.
The linear density of the yarn is 100 decitex, i.e. 100 grams per 10 000 meters.

### 4. Evaluation of the Elasticity of Copolymers 1 and 2

These properties are evaluated by means of a universal testing machine having a maximum capacity of 100 newtons and an accuracy of 0.25 newtons. This is the MTS C 42 device. The grips used are of Bollard 200 Newtons type. A pre-load of 0.02 N is applied to the yarn before deformation. The test consists in drawing a yarn having a length of L0=100 mm to a value Lmax=50%×L0, at a speed of 100 mm/min, and then returning to the initial length L0 at a speed of 100 mm/min.

TABLE 2

| | | Elastic |
|---|---|---|
| | Elongation | return |
| PEBA | (%) | (%) |
| 1 | 50 | 75 |
| 2 | 50 | 88 |

The elastic return expressed corresponds to the deformation of the yarn when the force reaches 0 newtons during the step of returning to the initial length L0. This value corresponds to L2 in the following formula:

$$Elastic return ( \% ) = ( \frac{Elongation Lmax - Deformation L 2}{Elongation Lmax} ) \times 100$$

The values expressed correspond to an average of five samples evaluated by reference.

### 5. Evaluation of the Elasticity of Copolymer 5

Elasticity was measured using a universal testing machine having a maximum capacity of 10 N and an accuracy of 0.05 N. This is the MTS C 42 device. The grips used are of flat rubber type. The initial length of the filament is L0=100 mm and a deformation rate of 100 mm/min. These conditions make it possible to identify the yield point of the filaments. A pre-load of 0.02 N is applied at the start of the test in order to limit the variation in the length of the foot of the curve. A break of 1 minute is applied before each elongation or relaxation. The values are based on a minimum of 5 test specimens or filaments.

TABLE 3

| | | Elastic |
|---|---|---|
| | Elongation | return |
| PEBA | (%) | (%) |
| 5 | 225 | 95 |

Under these conditions, the monofilament manufactured with copolymer 5, pre-drawn 4×, has an average elastic return of 95% in the case of 225% elongation.

### 6. Manufacture of a Woven Material

A textile material is produced by weaving yarns made of PA6 and 10% of filament of copolymer 5, in order to give the fabric elasticity. The weaving is carried out according to the known techniques.

### 7. Recycling of the Woven Material

The fabric is ground, in order to reduce it to particles. These are then melted. The mixture in the molten state is homogeneous. Granules are recovered after compounding and cooling.

It was observed that these granules could be reused to manufacture elastic filaments.

### 8. Manufacture of a Woven Material

An elastic textile material is produced by weaving only filaments manufactured with copolymer 5. The weaving is carried out according to the known techniques.

### 9. Recycling of the Woven Material

The fabric is ground, in order to reduce it to particles. These are then melted. The mixture in the molten state is homogeneous. Granules are recovered after compounding and cooling.

It was observed that these granules could be reused to manufacture filaments having an elasticity which is comparable to that of the initial filament.

1. An elastic filament comprising a copolymer containing polyamide blocks and polyether blocks,
the polyamide blocks being chosen from PA 11, PA 12, PA 1010, PA 1012, PA 1014, the copolymer thereof and the mixture thereof,
the polyether blocks being blocks derived from polytetramethylene glycol having a number-average molar mass of between 500 and 3000 g/mol,
the enthalpy of fusion of the copolymer being between 15 and 50 J/g.

2. The filament as claimed in claim 1, wherein the weight ratio of the polyamide blocks to the polyether blocks is between 0.3 and 3.

3. The filament as claimed in claim 1, wherein the hardness of the copolymer is between 30 and 55 ShD.

4. The filament as claimed in claim 1, wherein the polyamide blocks are chosen from PA 11, PA 12, the copolymer thereof and the mixture thereof.

5. The filament as claimed in claim 1, wherein the number-average molar mass of the polyamide blocks is between 500 and 4000 g/mol.

6. The filament as claimed in claim 1, wherein it is co-extruded with another thermoplastic material chosen from polyamides, polyethylene terephthalates, polypropylenes, polyethylenes, PEBA copolymers other than that previously defined.

7. The filament as claimed in claim 6, wherein it has the following structure: core-skin, sea-island or else trilobal.

8. A fiber comprising at least one filament as defined in claim 1.

9. The fiber as claimed in claim 8, wherein it comprises one or more synthetic filaments different from that previously defined and/or one or more natural filaments.

10. The fiber as claimed in claim 8, wherein it is commingled with at least one fiber made of a thermoplastic matrix different from the copolymer previously defined.

11. The fiber as claimed in claim 8, wherein it is continuous or discontinuous.

12. A textile material comprising at least one filament as defined in claim 1.

13. The textile material as claimed in claim 12, wherein it comprises at least one fiber made of a thermoplastic material chosen from polyamides, polyethylene terephthalates, polypropylenes, polyethylenes, PEBA copolymers other than that previously defined.

14. The textile material as claimed in claim 12, wherein it is a woven, knitted, nonwoven, or laminated surface.

15. The textile material as claimed in claim 12, wherein it comprises natural fibers such as chosen from cotton, wool, and silk, artificial fibers manufactured from natural starting materials, metal fibers and/or synthetic fibers other than fibers comprising copolymer filaments as previously defined.

16. A method of using the filament as defined in claim 1 for the manufacture of textile material for clothing, parts of sports shoes, sportswear, socks, bags, medical textile materials, bandages, support stockings.

17. A process for recycling the filament, the fiber or the textile material as defined in claim 1, wherein it comprises the following successive steps:
a) grinding the filaments, fibers or said material to obtain particles,
b) melting the particles to obtain a molten mixture, and
c) forming granules from the molten mixture obtained on conclusion of step b).
